(19) United States
(12) Patent Application Publication
(10) Pub. No.: US 2015/0080044 A1
(43) Pub. Date: Mar. 19, 2015

(54) DISTRIBUTED SPECTRUM MONITOR

(71) Applicant: Shared Spectrum Company, Vienna, VA (US)

(72) Inventors: Mark Allen McHenry, McLean, VA (US); Scott Seidel, Fairfax, VA (US)

(21) Appl. No.: 14/485,205

(22) Filed: Sep. 12, 2014

Related U.S. Application Data
(60) Provisional application No. 61/877,776, filed on Sep. 13, 2013.

(51) Int. Cl. H04W 4/00; H04W 74/08

(52) U.S. Cl. CPC H04W 4/006; H04W 74/0808; H04W 84/18
USPC 455/515

(57) ABSTRACT

Systems and methods are provided for distributed monitoring of radio frequency electromagnetic spectrum using dedicated and/or opportunistic sensors and varying sensor tasking assignments to collect, and optionally process collected data, that is used in conjunction with previously stored data and/or a plurality of models such as propagation models, terrain models, etc. Spectrum usage is sensed at multiple locations to obtain spectrum data, and integrated the spectrum data to form an information product that can be provided to a requestor, such as a secondary user of a region of spectrum.

This application claims the benefit of U.S. Provisional Application No. 61/877,776, filed Sep. 13, 2013, the disclosure of which is incorporated by reference in its entirety.

### 1 COPYRIGHT NOTICE

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright 2013, Shared Spectrum Company.

### 2 SUMMARY

The example, illustrative, technology herein relates to systems and methods for distributed monitoring of radio frequency electro-magnetic spectrum using dedicated and/or opportunistic sensors and varying sensor tasking assignments to collect and optionally process collected data that is used in conjunction with previously stored data and/or a plurality of models such as propagation models, terrain models, etc.

The technology herein has applications in the areas of spectrum management and monitoring, spectrum leasing and regulatory enforcement, emission source tracking, and dynamic spectrum access (DSA).

Example embodiments disclosed herein include techniques and systems for sensing spectrum usage at multiple locations to obtain spectrum data, and integrating the spectrum data to form an information product.

Example embodiments may include obtaining spectrum data from a plurality of spectrum sensors, and, in response to a request, providing an information product based upon the spectrum data to a requestor as disclosed herein.

Example embodiments may provide methods and techniques for operating a wireless spectrum sensor as disclosed herein, for example by receiving multiple request to perform a spectrum sensing task, determining whether to perform each task, and performing one or more of the requested tasks as disclosed herein.

### 3 BRIEF DESCRIPTION OF THE DRAWINGS

The features of the present invention will best be understood from a detailed description of the invention and example embodiments thereof selected for the purposes of illustration and shown in the accompanying drawings in which:

FIG. 1 is a diagram illustrating the relationships between the elements of an example implementation.

FIG. 2 is a diagram illustrating example interactions between elements in an example implementation.

FIG. 3 shows a process flowchart illustrating integration of continuous mode sensing with an example system implementation.

FIG. 4 shows a process flowchart illustrating integration of request-handling sensing with an example system implementation.

### 4 DETAILED DESCRIPTION

### 4.1 Overview

A distributed spectrum monitoring system provides a system platform and architecture for integrating disparate information sources such as various types of sensors, transceivers, and RF or other models in order to enable the creation of synthesized information. The synthesized information is then provided to one or more information consumers.

The synthesized information may be used by the distributed spectrum monitoring system to identify missing, incomplete, contradictory, or other information about spectrum allocation, usage, or for operational information.

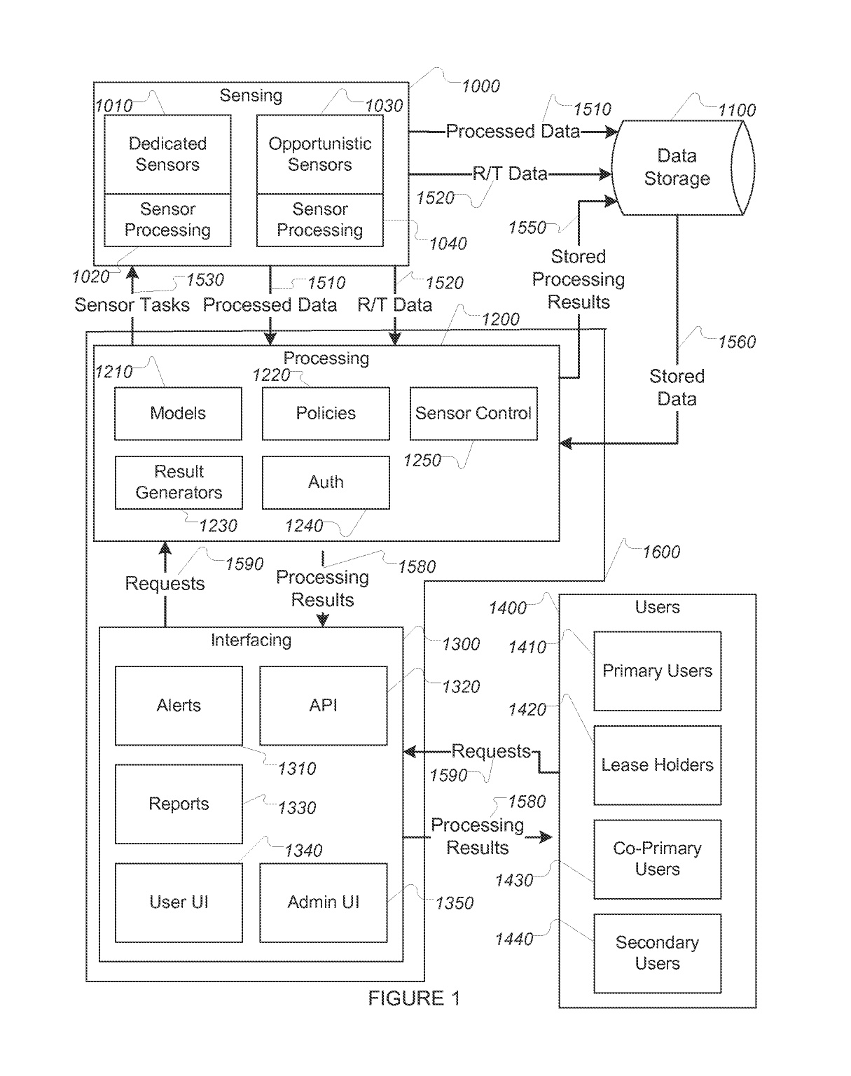

As illustrated in FIG. 1, the system includes at least one monitoring component (1600), further comprising processing (1200), interface (1300), and data storage (1100) subcomponents, one or more disparate sensors (1000), and one more users (1400). The monitoring component preferentially may be implemented using common computer systems, such as one or more servers, laptops, embedded, or other computer systems, including the well-known components of CPU, storage (e.g., RAM, ROM, disc drive, flash drive, and the like), and interfaces, including radio and networking interfaces. Subcomponents of the monitoring component may be distributed across a plurality of computer systems if required.

The data storage subcomponent (1100) includes one or more data storage systems of known design. The data storage systems may be integrated or standalone, and may be co-located with elements that store or retrieve information from them, or may be remotely provided using a computer network (wired or wireless). They may be implemented using a variety of different technologies, including DBMS systems, simple files, or other on-line data storage. These systems are typically non-volatile, but may incorporate volatile storage as needed. Data Storage holds processed and real-time data from sensors, computed results, metadata, as well as information necessary for the operation of the system, such as information about available sensors, authorization and authentication values, terrain map data, localization information for human-readable outputs (e.g., reports, alerts, etc.), and configuration information, such as threshold values, frequencies to monitor, etc.

In some implementations, data storage may include external databases, such as spectrum access databases, which may include licensed frequency information, databases of known transmitters, and other information.

The processing subcomponent (1200) further includes components for processing models (1210), policies (1220), sensor control (1250), authentication and authorization (1240), and result generators (1230), as well as the implementation logic required to process API (1320) calls and other requests for information from the system.

The Models subcomponent (1210) includes the data and/or processing instructions for calculating information for one or more integrated information products. For example, the models subcomponent may include calculations and stored results for propagation models, time difference of arrival methods for determination of relative positions of emitters and receivers, interference models for determination of minimal frequency or spatial separation between emitters, etc. Some aspects of the models subcomponent (1210) also may be useful for calculations used internally by the system, such as for prediction of user requests based on historical data that permits pro-active sensing to collect the data that will be needed to service them, modeling of sensor reliability for use in preventative maintenance planning, and the like.

The Policies subcomponent (1220) includes the specifications for use in determining authorization or authentication, use of models, thresholds, frequency allocation requirements, etc. and the logic to encode these specifications to sensor specific implementations. In some implementations, the policies subcomponent includes communications subcomponents to communicate policy to sensors.

The Result Generators subcomponent (1230) produces Computed Results (1580), such as reports, alerts, generated data or metadata for storage (e.g. calculated emitter locations, heat maps of signal strengths, and the like), tasks for sensors, etc.

The Authentication and Authorization (1240) subcomponent handles authentication and/or authorization processing for system components, including distributed subcomponents, databases, sensors, users, and admins.

The Sensor Control subcomponent (1250) is responsible for managing sensors. This includes keeping track of available sensors (e.g. type, location, reliability, capabilities), handling negotiation of available capabilities (frequency range, sample rate, sensor processing resources, etc.), selecting appropriate sensors as needed, and assigning tasking.

The Interface subcomponent (1300) includes facilities for making requests of, or obtaining results from, the system. Interfaces are provided using techniques understood to those skilled in the art. Requests are typically for computed results, but can also be for stored data, real-time data feeds, current sensor tasking, or for configuration changes, such as adding user accounts, changing authentication or authorizations, or other needs. The interface subcomponent may also receive real-time data feeds and sensor data from sensors. The Interface subcomponent further includes subcomponents for Alerts (1310), API (1320), Reports (1330), User (1340), and Administrative UI (1350).

The Alerts interface subcomponent (1310) manages notifications to users or admins resulting from events, non-events, or error conditions. The Alerts interface subcomponent can also manage notifications to subcomponents, such as for notification of system shutdown, initiation of report generation or other processing activities.

The API subcomponent (1320) provides a programmatic interface for connection with external systems and/or between components. It accepts requests and returns results of request processing. Requests can be made by any known methods as determined to be proper by those with skill in the art, such as subroutine invocations of library routines, message passing through OS facilities, remote function calls using such well known methods as RPC or SOAP, or remote object accesses through methods such as ORB or CORBA.

The Reports subcomponent (1330) provides the processing mechanism for creating outputs for users or other subcomponents using processed and/or raw data in the system. For example, the reports component may integrate processed and raw sensor data to produce grid or polygonal contour map representations of the data. Production of a requested report can require that additional sensor data be collected when stored data is not sufficient. In such cases the reports subcomponent (1330) interacts with other subcomponents, such as the sensor control subcomponent (1250), to cause the required data to be acquired.

The User UI subcomponent (1340) provides one or more interfaces for the use of users to make requests and/or receive results. Typically, the user UI includes a GUI interface, though other interfaces, such as command line inputs and text display outputs, SMS text messaging, or voice recognition and generation interfaces are possible.

The Administrative UI (1350) provides an interface for privileged interaction for system control, such as creating authorizations, setting sensor reliability values, system maintenance, setting policies, etc. The results of these actions control the processing subcomponent operation. Administrative UI (1350) can be implemented using methods similar to those described above for User UI (1340).

Users may be operating using independent computing systems, such as desktop or laptop computers, embedded computing systems, cognitive radio transceivers, or upon one or more sensors. Each user has the use of a computing system of known manufacture (e.g. CPU, storage, interfaces) that is operable to send requests to and receive responses from the monitoring component. In some implementations, this computing system is stand-alone, such as desktop or laptop computer. In other implementations, the computing system is part of a cognitive radio or a dedicated sensor system.

Sensors (1100) collect real-time RF data and metadata (spectrum use by frequency, time data was collected, location data was collected, etc.). Sensors can process data locally and store processed results, with or without storage of the raw data, or store raw data for later processing. Processing can include power determination by frequency, emitter classification, location, and broadcast pattern results, or other results. Sensors can send collected and/or processed data to one or more processing subcomponent(s), or send collected and/or processed data through hierarchical or other networking arrangements to one or more data storage components.

Sensors (1100) include dedicated sensors (1010), and opportunistic sensors (1030), which further include mobile and fixed transceivers, base stations, and other cognitive radio systems of known design. Sensors are typically constructed from dedicated hardware, or by using a computing system of known manufacture, operably coupled with a receiver and optionally coupled with a transceiver and/or wired communication means. Each type of sensor may have varying capabilities, such as operating frequency and/or onboard signal processing capability. Sensors are connected to the monitoring component using wired or wireless means, such as known methods of networking and radio communications.

Each of the various components and subcomponents disclosed herein may be implemented on one or more special- or general-purpose computers. Multiple components and/or subcomponents may be implemented on a single such computer, and/or individual components and/or subcomponents may be implemented on individual computer systems. Unless indicated otherwise, any arrangement of individual or multiple computers may be used to implement the systems and techniques disclosed herein.

The distributed spectrum monitoring system differs from existing systems, for example, because it may integrate data from a variety of distributed sensors, perform modeling on the collected information, and/or manage sensors in order to obtain data needed for its processing.

### 4.2 Definitions

The following definitions relevant to the example architecture elements of FIG. 1 are used throughout, unless specifically indicated otherwise:

| Term | Definition |
|---|---|
| Co-Primary | A primary user that doesn't have exclusive use of spectrum |
| Users | in an area. For example, two primary users that use DSA |
| (1430) | to coordinate spectrum use between themselves, but not |
| | to avoid interfering with secondary users. |
| Dedicated | A sensor intended exclusively to collect data for the system. |
| Sensor | |
| (1010) | |
| Lease | Users that have made arrangements with a primary user |
| Holders | to share the primary user's spectrum. Lease holders are |
| (1420) | treated as primary users by secondary users. |
| Opportunistic | A device intended primarily for other purposes that can |
| Sensor | be used as a sensor at least some of the time. For example, |
| (1030) | a DSA radio that can share data about spectrum use it detects. |
| Primary | Users with primary rights to use given spectrum in an area |
| Users | without undue interference by non-primary users or |
| | adjacent primary users. |
| Processed | Processed Data is real-time data that is manipulated, |
| Data | perhaps over time, to reduce its size, characterize it, or |
| (1510) | otherwise increase its value or ease its handling. For example, |
| | power level determination by frequency, average power level |
| | over time, detection of signals, classification of detected |
| | signals, reduction of noise, filtering out of selected signals |
| | or frequencies, etc. |
| Computed | Responses to requests. Can include yes/no answers, frequency |
| Results | assignments or leases, raw data, map outputs (e.g. heat maps |
| (1580) | of signal strengths, spectrum maps for a location, |
| | propagation patterns from a given location, BDI maps for |
| | emitter locations, etc.) |
| Requests | Requests are commands to produce-various types of results. |
| (1590) | Requests originate with users (or their systems) that want to |
| | determine such things as frequency availability, exclusion |
| | zone locations, locations of interfering emitters, quiet areas, |
| | propagation estimates for specific locations, etc. |
| Real-time | (abbreviated R/T Data) Data input to Processing directly |
| Data | from sensors, rather than from Data Storage. Real-time data |
| (1520) | production can be as simple as A/D conversion, or more |
| | complex, such as determination of whether signal above a |
| | noise floor is present, adjustment of signal levels, etc, |
| | Metadata can also be generated and associated with real-time |
| | data, such as time of collection, sensor type, sensor ID, or |
| | sensor configuration. Real-time data is produced in sensing |
| | components. Real-time data is optionally stored in Data |
| | Storage. |
| Secondary | Users that use spectrum opportunistically so long as they |
| Users | don't interfere unduly with primary user use of spectrum. |
| (1440) | |
| Sensing | Sensors are of two varieties: dedicated and opportunistic. |
| (1000) | |
| Sensor | Sensor data processing element(s) located within, with, or |
| Processing | accessible to a sensing element, with access to the full raw |
| (1020 & | data feed from the sensing element and optionally capable of |
| 1040) | controlling one or more behaviors of the sensing element. |
| | Used to carry out sensor tasking, to process raw sensor |
| | outputs as required to produce Real-time data and/or |
| | Processed Data. |
| Sensor Tasks | Requests to one or more sensors to collect specific data, to |
| (1530) | collect data at specified times, to process data in |
| | specified ways, etc. |
| Stored Data | Data stored in Data Storage. For example, historical sensor |
| (1560) | data for determining use patterns, stored terrain maps to |
| | model propagation patterns, authorization or authentication |
| | information, threshold values, terrain maps, etc. |
| Stored | The results of processing sensor data are stored for future |
| Computed | use. For example, reports can he saved for later printing, |
| Results | signal type and location information can be stored for use in |
| (1550) | determining patterns of use, propagation data can be |
| | stored and used to update propagation models, etc. |
| Users | Entities with need to make requests or to obtain results from |
| (1400) | the system. |

### 4.3 Example System Architecture

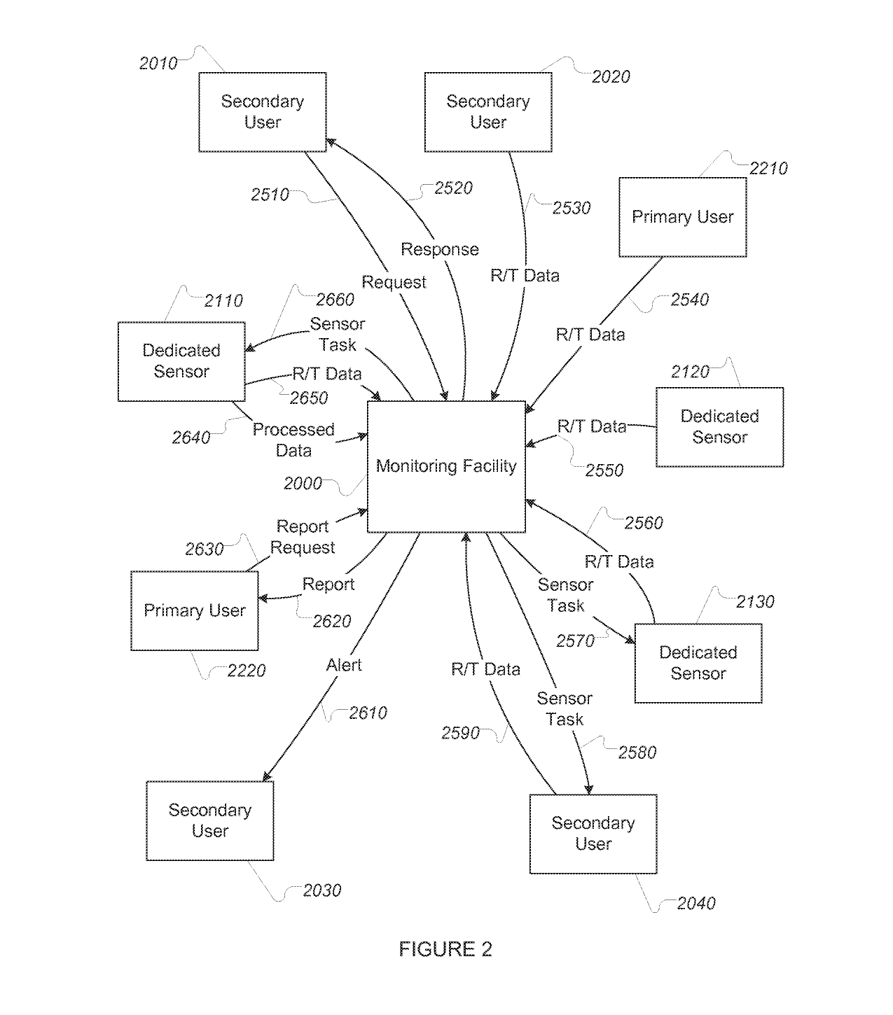

FIG. 2 shows several examples of example interaction between example monitoring system components. A monitoring component (2000) is in contact with various primary users (2210 & 2220), secondary users (2010, 2020, 2030, & 2040), and dedicated sensors (2110, 2120, & 2130).

The monitoring component can be configured with one or more models that it can periodically calculate or re-calculate as part of its processing. The monitoring component can be configured with models that are used as provided, and not calculated or re-calculated by the monitoring component. Calculation or re-calculation of a given model may be triggered based upon a time interval since the previous calculation or re-calculation, generation of an alert, upon receipt of one or more pieces of data from a sensor, or upon the basis of a request from a processing subcomponent such as another model. For example, a first model being processed by the system may require information that can be provided by a second model. The first model requests the processing subcomponent to process the second model to produce the needed information. In some scenarios the second model can determine that the second model is out of date and initiate re-calculation of itself before producing the information needed by the first model. Alternatively, a user request may be made for one or more pieces of information and the processing component determines the information to be generated (e.g. by a model) or collected. Similarly, while processing a model, the monitoring component may identify one or more additional pieces of information that are required, and then generate task requests to one or more sensors to obtain the needed information. The sensors may be selected based upon previously collected information, metadata about the sensor, sensor capability (for example, frequencies that can be monitored, onboard processing capability, etc), or negotiated information related to sensor availability. Once all required data is received, the model processing continues. A plurality of models may be processed simultaneously by the monitoring component.

As model processing continues one or more information results may be generated and stored in at least one of the data stores. For example, a model may calculate spectrum availability based upon spectrum utilization reports from one or more sensors and store the resulting spectrum availability information in a database. Alternatively, the model may calculate the location of each report and determine polygonal or map contours (mapping information) where specific spectrum availability characteristics may be expected. Other, more complex information may be used and generated, such as belief/disbelief/ignorance calculations related to specific emitters, sets of emitters, or area attributes, exclusion zone boundaries, etc. The model may cause the mapping information to be stored in a data store, and may even generate a notification to the reporting subcomponent so a map report may be generated using the newly calculated information.

Thus, the system operates in several ways. First, it provides a framework for processing data and models to create aggregated result information from a plurality of disparate sources, storing the created information, and then using the created information to produce one or more information products (processing results) based upon this information. For example, the system operates by determining areas that meet one or more criteria in accordance with the models, including contour areas of spectrum coverage, exclusion zones, emitters, etc., and then provides this information in the form of one or more specific reports or alerts to a user. Additional examples are given below in relation to FIG. 2.

A first primary user (2210) may provide real-time data (2540) to the monitoring component (2620). This real-time data may include, for example, sensed data concerning emissions by other primary users or secondary users, and/or sensed data about the first primary user's emissions, such as power and frequency in use. Alternatively or in addition, the real-time data may further include information calculated about the sensed data, such as calculated values for spectrum utilization and/or beliefs regarding spectrum utilization. Alternatively or in addition, the real-time data may further include metadata information, including metadata about the sensor (e.g. sensor ID, location, a time the data was collected, etc.) and onboard processing (e.g. types of processing performed, classifiers used). A second primary user (2020) may request information (2630) from the monitoring component, such as a list of open frequencies, emitter locations by frequency, current propagation model value updates, etc., and the report is sent back from the monitoring component (2620).

A first secondary user (2010) may make a request (2510) of the monitoring component. The monitoring component processes the request, determines how to produce the desired result(s), produces the desired results, and returns the requested information (2520) to the requestor. The request may include specific information, such as for an available frequency, general information, such as a heat map report showing signal strengths for various locations in the area, or specific queries, such as a yes/no response as to whether the secondary user is currently located in an exclusion zone.

A second secondary user (2020), operating as an opportunistic sensor, may provide real-time data (2530) to the monitoring component without having been specifically tasked to do so. Some example embodiments may use a “standard data feed” that sensors can provide if they choose to, or if policy specifies that they do so. Other example embodiments may use one or more standard data feeds that a sensor can be configured to use to send data to a monitoring component. Data sent may include real-time data, processed data, or both, as specified by the communications standard in use, or by as specified by an external policy that defines the information to be sent. In at least some example embodiments, a sensor control monitoring component instructs one or more sensor(s), whether opportunistic or dedicated, not to send some or all of the data to the monitoring component until or unless the data is requested. For example, the monitoring component may instruct the sensor not to send standard data feed data or other data until such is requested, or until some event at the sensor occurs. Examples of such events include processing events, such as a cache being full, or an amount of cached data exceeding a specified threshold; time events, such as an interval of time since data was last sent to the monitoring component; and/or data events, such as usage on a specific frequency occurring or exceeding some determined threshold value. Limiting transmission of data from a sensor to the monitoring component may provide numerous benefits, such as reducing bandwidth use, reducing sensor detectability, lowering overall power emission levels in the sensor's vicinity, reducing interference caused by data transmissions, reducing workload on the monitoring component, or the like.

In some embodiments, sensor data can be calibrated by the monitoring component without requiring cooperation from sensors being calibrated. For example, by using stored data, such as known emitter locations and characteristics, terrain maps, etc., metadata supplied by sensors, such as sensor location, movement vector, antenna type and pointing direction, etc. and/or models such as propagation models and Doppler models, the predicted power at the receiver can be computed and compared with the reported sensed power. Differences between computed and sensed power provides calibration information for the sensor. The calibration information may be stored in the data store by the monitoring component, and subsequently may be used to adjust information reported by the sensor to the monitoring component. The adjustment may occur to the data when it is received by the monitoring component, after the data is received. It also may occur before the data is made available for use by other sensors operating with the monitoring component, and/or by the monitoring component's processing steps. In another example, multipath arrival time data from known emitters can be used as a check on reported sensor location.

Sensor performance in supplying real-time data or Processed Data can vary with such factors as processor computing power, available device resources, and data link speed and the distance between the monitoring component and the sensor. Delay in reporting sensed data can be calibrated using synchronized clocks and time stamps in data in some cases, and by use of differential arrival times of data concerning the same emissions as reported from different sensors. In some cases models it may be desirable to adjust models for differences in sensor and emitter locations, movement of either, or other factors.

A third secondary user (2030) receives an alert (2610) from the monitoring component. Alerts can be of a variety of types, with varying characteristics. For example, alerts can notify a user (or more accurately: a user's device) that undue interference with a primary user is being caused by its current operations, that an exclusion zone is about to be entered or created, that there is a better frequency available for its use, that an update to a previously requested report is available, or about any other event, non-event, or error condition detected or predicted by a monitoring component.

A fourth secondary user (2040), operating as an opportunistic sensor, has been tasked (2580) by the monitoring component (2000) to perform sensing, and to return real-time data back to the monitoring component (2590). Note that in some cases, tasking can require that a sensor returns to the monitoring component other than real-time data. For example, a sensing task can require only that a sensor monitor a frequency range for peak power level, and to send an alert if and when the peak power lever sensed exceeds a threshold. In another example, a sensing task can require sending information on channels seen to be active within a specified recent period of time, or whether a specific signal type has been detected. Sensor tasking can also specify that selected data or all data not be sent to the monitoring component (2000). This can be used to modify previous tasking, to override default sensor data collection and/or transmission behavior, or for any other reason. In some example embodiments, sensor tasking also may include calibration instructions to cause the sensor to adjust real-time data prior to sending it or using it in producing processed data. Prior to sensor tasking, a monitoring component may engage in a negotiation with a sensor to determine its capabilities and/or availability for tasking by the monitoring component. This may allow any tasking issued by the monitoring component to be within the capabilities of the sensor and within the availability limits offered. For example, a sensor may have the capability to process data, but due to demands of its user, not be able to devote resources to doing so for sensor tasking. Initiation of negotiation between a sensor and a monitoring component can be done by the either party, depending on implementation details of a given embodiment. Some tasking limits can involve, but are not limited to:
Bandwidth
Frequency range
Channel width
Sample rate
Processing beyond real-time data requirements
Data transmission rate

Specific limitations can depend on the values of these factors. For example, a wide bandwidth with a narrow channel width could result in a large bucket count for FFT processing that exceeds the memory or processor capabilities of a given sensor, while a wider channel width and/or narrower bandwidth to be sensed would not. Such limitations can be specified during negotiation in some embodiments or scenarios while in other embodiments or scenarios limitations are dealt with through rejection of specific tasking.

In some example embodiments, sensors can be tasked by a plurality of monitoring components (2000), and in such embodiments it is possible that tasking by diverse monitoring components (2000) can be in conflict. For example, a first monitoring component can task a sensor to collect data in a first frequency range, while a second monitoring component tasks the sensor to collect data in a second frequency range, and the sensor design permits collection of data in only one frequency range at a time. In a second example of tasking conflict a first sensor can task a sensor to perform data processing on collected data that requires 60% of the sensor's total computing power, while a second sensor tasks the sensor to perform data processing on collected data that requires 70% of the sensor's total computing power. Performing both tasking assignments would require 130% of the sensor's total computing power, which is not possible.

Resolution of such conflicts can be handled in any of several ways. For example, one tasking assignment can be accepted and the other rejected. The choice of which to accept and which to reject can in some non-limiting example embodiments be based on any of, or combination of, the following:

Accept the first tasking request o arrive and reject others.

Accept the tasking request with the highest priority, where the priority of a tasking request is determined based on policy.

Accept a tasking request that can be carried out with currently available capabilities over a tasking request that requires acquisition of, for example, additional software for processing data.

Accept a tasking request that involves lower resource consumption over a tasking request that involves higher resource consumption. For example, tasking that requires that real-time data be sent as it is collected can involve lower resource consumption than tasking that requires that real-time data be collected for 30 minutes, and an average power level value be sent.

Accept the tasking request that can be carried out in shortest time period. For example, a tasking request to sample for 1 minute can be preferred over a tasking request that requires sampling for an hour.

In some example embodiments a sensor will first determine whether two tasking requests can be satisfied with the same operations. For example, if a first tasking request requires collection of power level data for channels between a first frequency and a second frequency and a second tasking request requires determination of the average power level for channels between the same two frequencies, both requests can be satisfied by the same data collection operations. The second request requires additional processing of the data, but by the time that is done, the first tasking request has been satisfied so there is no conflict and the sensor can accept both tasking requests.

In some example embodiments, prior to determining whether two tasking requests conflict, or whether a tasking request involves greater resource use than is currently available, a sensor will first determine whether the required sensing and/or processing will be done anyway, such as for device normal functionality (e.g. a DSA radio operating as an opportunistic sensor that is scanning a range of frequencies to locate an available backup channel will have data on power by frequency for that frequency range and can accept a tasking request to send that data at little resource cost). When the tasking request requires collection or processing that will be done even in the absence of such a request, accepting the tasking request imposes little or no additional burden on the sensor and can be accepted, or preferred over an otherwise conflicting tasking request.

Alternatively or in addition to tasking of specific sensors, in some configurations a broadcast request for specific data may be provided to one or more sensors. Any sensor capable of supplying the requested data, and willing to do so, may respond by sending the requested data. For example, a broadcast request could ask for locations where LTE signals have been detected, locations currently seeing a peak power above a specific threshold for a specified channel, or sensors willing and capable of accepting a specific sensor tasking assignment.

In the example, a first dedicated sensor (2120) is shown feeding real-time data (2530) to the monitoring component without having been specifically tasked to do so, as described above for the second secondary user (2020). Such a data feed can also result from a broadcast request for the data.

A second dedicated sensor (2130) is shown feeding real-time data (2560) as a result of sensor tasking (2570). Dedicated sensors may or may not be involved in a negotiation step as described above. In some cases the characteristics and capabilities of dedicated sensors are known to a monitoring component through configuration settings, design, or otherwise, and no negotiation step is required in such cases.

A third dedicated sensor (2110) has been tasked (2660) to return both real-time data (2650) and Processed Data (2640). Processed data (2640) can include information calculated from the sensed real-time data, such as calculated values for spectrum utilization, beliefs about emitter presence, classification of signals, or the like, and/or metadata about real-time data used to produce the processed data or the processing done with it. For example, it may include metadata about the sensor (e.g. sensor ID, location), processing performed (detection, classification, noise elimination, power spectrum calculation, etc.), and capabilities used in performing processing (e.g. classifiers used, threshold used for noise detection, or bin size used for power spectrum calculation). Depending on the tasking, either or both forms of data may be sent to data storage or to a processing component for immediate use, or to both.

### 4.3.1 Monitoring Modes

Monitoring components may operate simultaneously in at least two modes: continuous and request handling. Continuous mode operates to collect sensor data as specified by policy, process it, and generate alerts and computed results also as specified by policy. Request handling mode is driven by the arrival of requests for computed results. Each of these modes is described in more detail below.

### 4.3.1.1 Continuous Mode

In continuous mode, the monitoring component accepts real-time data and/or Processed Data from sensors, retrieves Processed Data or other data from Data Storage as required, tasks sensors as necessary to obtain any additional data required, and processes the data to create processing results as specified by policy, storing them in data storage for future use or outputting them through one or more interfaces, such as a User UI on a monitor screen, through printed or e-mailed reports, by invoking API functions, or as alerts. The result generators that process the data can make use of models as necessary, and may use authentication results to weight or select data.

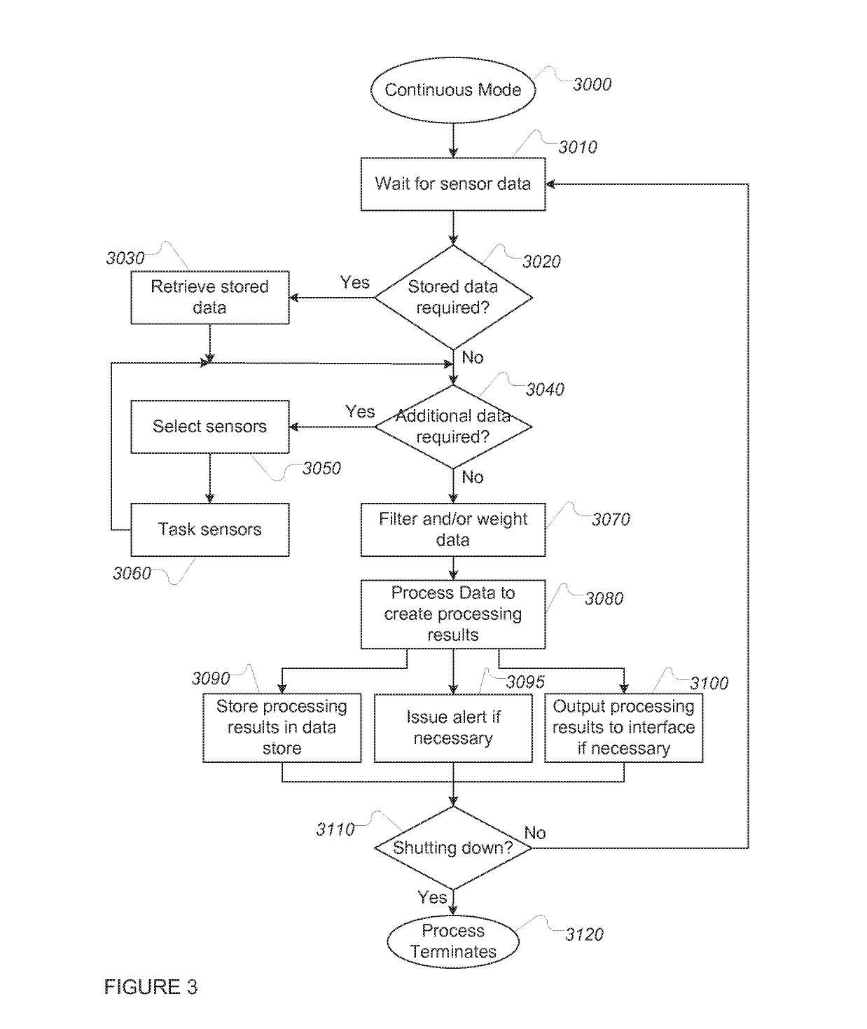

FIG. 3 is a flowchart describing this process (3000). When a sensor sends data (3010), a check is made of policy to see what processing is required. If the processing involves use of stored data (3020), such as terrain maps, historical data, known emitter locations, etc., the stored data is retrieved (3030) from data storage. Processing of the sensor data and/or the stored data can result in a need for additional data in some cases (3040). If additional data is required, sensors that can potentially provide the data are determined (3050) and tasked (3060) to collect the data. If the required data is not made available by the tasked sensors (3040), additional sensors may be selected and tasked. In some embodiments the initial selection and tasking of sensors may be restricted to dedicated sensors, to sensors most likely to be able to supply the required data, or to sensors not otherwise tasked. If additional rounds of selection and tasking are required, the pool of sensors involved can be expanded, for example by including less capable sensors, busier sensors, or sensors less well-placed to collect the information, or by other methods. In some example embodiments the tasking request can be modified to make it acceptable to one or more sensors when there are no sensors capable or willing to accept the tasking. For example, if two frequency ranges must be scanned in a given location, but no sensor will agree to perform the task, the task can be divided such that a first frequency range is tasked to a first sensor, and the second frequency range is tasked to a second sensor, rather than both frequency ranges being tasked to a single sensor. Reducing the resource consumption, capabilities required, or otherwise adjusting the tasking request can make a tasking request more acceptable in some scenarios. This continues until the required data is available (in some embodiments a timeout can be implemented that causes an error condition if the data is not acquired within a policy-specified time period or within a policy-specified number of sensor selection/tasking rounds).

Once the required data is available (3040), the data can, in some embodiments, be filtered or weighted by various factors (3070). For example, sonic sensors, such as dedicated sensors, may be considered more reliable or trustworthy than opportunistic sensors, so the data supplied by opportunistic sensors may be weighted less than data from dedicated sensors. Likewise, a sensor closer to the location required for a proper measurement may have its data weighted more heavily than a sensor located farther from that location, or more recently collected data may be weighted more heavily than older data. In some cases data older than a specified limit may be filtered out completely and not used in processing.

In example embodiments where trustworthiness of sensors is a factor in weighting of sensor data, trustworthiness can be based on a plurality of factors. For example, an example embodiment can base trustworthiness on one or more of:

Policy specification of trustworthiness values for some or all sensors. Specification of sensors can be by individual sensor, by sensor type (e.g. model, spectrum analyzer, DSA radio, etc.), by sensor class (e.g. dedicated vs. opportunistic, base station vs. client device, mobile vs. fixed location, etc.), by sensor owner/operator type (e.g. primary user vs. secondary user vs. unknown), by sensor network membership, or by other methods.

Sensor location or movement in combination with one or more models (e.g. propagation, terrain, etc.). For example, a stationary sensor may be considered more trustworthy than a moving sensor due to Doppler effects or issues around changing multi-path factors. A sensor in one location may be considered more reliable than a sensor in another location due to terrain effects, interference from local emitters, or the presence of “spoofing” devices.

Sensor trustworthiness can, in some example embodiments, be determined over time by historical reliability as determined by comparison of reported data with data sent from trusted sensors, by user feedback about prior sensor data, or checks of reported data against data from stored data. For example, if a sensor reports a known emitter at an incorrect location, the sensor's trustworthiness can be decreased, while if it reports the known emitter at its known location, the sensor's trustworthiness can be increased.

Policy can specify a trustworthiness threshold that a sensor must exceed for its data to be used. In some example embodiments a plurality of thresholds can be specified, where the applicability of a given threshold can be specified based on sensor type, location, class, or other factors.

Once the data has been filtered and/or weighted as required, the data is processed to create processing results (3080), such as emitter location estimates, heat maps of interference levels by location, sensor list updates, etc. These results can be stored in the data store (3090), output to an interface (3100) such as a monitoring screen or meter, or used to trigger one or more alerts (3095), as determined by the design of the processing elements, or the configuration of the processing system as specified in policy.

Once the processing and handling of the computed results is complete, a check is made to see if the system is shutting down (3110). If it is, the process is complete (3120), otherwise the process returns to waiting for sensor data (3010).

### 4.3.1.2 Request Handling Mode

In request handling mode the monitoring component accepts a request made through one or more interfaces, such as an API call, a command entered by a user, reception of an alert, or the like, and processes the request to produce the requested computed results. Result generators can make use of models, policies, stored data, and sensor tasking in producing the computed results. For example, a request for a clear channel from a primary user could involve spectrum power or detected emitter sensor data, both current and recently stored, propagation models, terrain maps, stored information on the primary user's location and power output capabilities, authentication to ensure that the request came from a primary user, and sensor tasking to collect additional data where current sensor inputs and stored data are inadequate. Process results may include a single channel specification, a set of possibilities, and/or additional data such as how recently the specified channel became clear or the average time it remains clear, depending on system design, policy, and the specifics of the request.

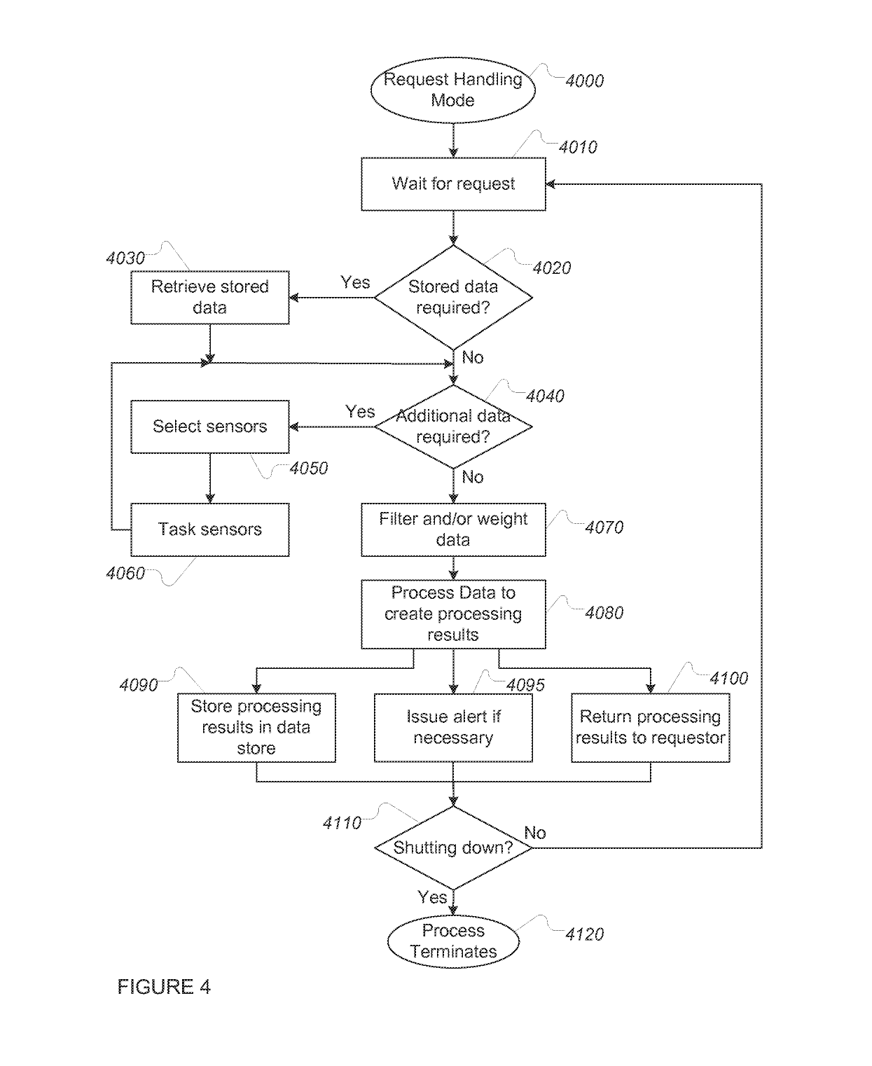

FIG. 4 is a flowchart describing example processing in request handling mode. The process (4000) starts by waiting for a request to arrive (4010) through an interface, such as a user UI, an API call, or an alert generated from other processing. The nature of the request determines the processing required, and a check is made to see of the required processing needs stored data (4020), such as terrain maps, historical data, known emitter locations, etc. If so, the stored data is retrieved (3030) from data storage. Processing of some requests can result in a need for additional data not located in data storage, such as real-time data. If additional data is required (4040), sensors that can potentially provide the data are determined (4050) and tasked (4060) to provide the data as described above for continuous mode. Once the required data is available (4040), the data can, in some embodiments, be filtered or weighted by various factors (4070) as described above for continuous mode.

Once the data has been filtered and/or weighted as required, the data is processed to create the requested computed results (4080), such as emitter location estimates, heat maps of interference levels by location, available channels, etc. These results can be stored in the data store (4090), returned to the requestor (4100), and/or used to trigger one or more alerts (4095), as determined by the design of the processing elements, or the configuration of the processing system as specified in policy.

Once the processing and handling of the request is complete, a check is made to see if the system is shutting down (4110). If it is, the process is complete (4120), otherwise the process returns to waiting for a request (4010).

Although various embodiments are described herein with respect to first, second, and other components or users for illustration, it will be apparent to one of skill in the art that in some cases more than one of the described example users may refer to a single component or user. For example, the first secondary user described herein also may perform some or all of the functions, and provide or receive some or all of the information described with respect to the second, third, and fourth secondary users. More generally, unless indicated otherwise, any operations described as being performed by a component or user may be preformed by any appropriate component or user.

It will be recognized by those skilled in the art that, while the invention has been described above in terms of preferred embodiments, it is not limited thereto. Various features and aspects of the above described invention may be used individually or jointly. Further, although the invention has been described in the context of its implementation in a particular environment, and for particular applications, those skilled in the art will recognize that its usefulness is not limited thereto and that the present invention can be beneficially utilized in any number of environments and implementations. Accordingly, the claims set forth below should be construed in view of the full breadth and spirit of the invention as disclosed herein.

What is claimed:

1. A system comprising a plurality of RF sensors, each of the plurality of RF sensors disposed at one of a plurality of locations;
wherein each of the plurality of RF sensors senses spectrum usage at the one of the plurality of locations at which the each of the plurality of RF sensors is located to obtain spectrum data at the location; and
wherein the system integrates the spectrum data from each of the plurality of RF sensors to form an information product.

2. The system of claim 1, wherein the information product is integrated from a combination of spectrum data obtained by each of the plurality of RF sensors and one or more data-driven models.

3. The system of claim 2, where the data driven models include use of a spectrum access database.

4. The system of claim 1, where the information product comprises a grid or polygonal contour map including the plurality of locations and indicating spectrum usage at each of the plurality of locations.

5. The system of claim 1, wherein at least one of the plurality of RE sensors is an opportunistic sensor.

6. A method comprising:
providing a plurality of sensing tasks to a plurality of spectrum sensors, each spectrum sensor located at one of a plurality of locations;
obtaining spectrum data from each of the plurality of spectrum sensors in response to each spectrum sensor performing at least one of the plurality of sensing tasks;
deriving spectrum usage data from the spectrum data received from each of the plurality of spectrum sensors; and
responsive to a request, providing an information product based upon the spectrum data to a requestor, the information product describing spectrum usage in at least one of the plurality of locations.

7. The method of claim 6, further comprising:
continuously monitoring the spectrum data from each of the plurality of spectrum sensors during a period of time; and
in response to usage of a region of spectrum sensed by at least one of the plurality of spectrum sensors during the period of time, alerting a secondary user of the region of spectrum.

8. The method of claim 6, wherein the requestor is a secondary user of spectrum sensed by at least one of the plurality of spectrum sensors, and wherein the spectrum usage data comprises an indication of spectrum usage by a primary user of the spectrum sensed by at least one of the plurality of spectrum sensors.

9. The method of claim 6, wherein the spectrum data comprises receiving real-time data from a first of the plurality of spectrum sensors.

10. The method of claim 9, wherein the real-time data comprises a data item selected from the group consisting of: sensed data concerning emissions by a primary user; sensed data concerning emissions by a secondary user, sensed data describing emissions by a primary user, a calculated value of spectrum utilization, and meta data information describing the first of the plurality of spectrum sensors.

11. The method of claim 6, wherein at least one of the plurality of spectrum sensors is an opportunistic sensor.

12. The method of claim 6, further comprising:
instructing at least one of the plurality of spectrum sensors regarding at least one operation selected from the group consisting of: a type of real-time data to provide; a type of processing to apply to sensed data, and a combination thereof.

13. The method of claim 6, further comprising:
providing an alert to a secondary user regarding an event identified based upon the spectrum data.

14. The method of claim 6, further comprising:
assigning a sensing task to at least one of the plurality of sensors.

15. The method of claim 14, further comprising:
negotiating with the at least one of the plurality of sensors to determine an availability of the sensor to perform the sensing task.

16. The method of claim 1, further comprising:
broadcasting a request to perform a sensing task to the plurality of sensors.

17. The method of claim 6, further comprising:
receiving the request from a secondary user.
